(19) United States
(12) Patent Application Publication
(10) Pub. No.: US 2025/0348174 A1
(43) Pub. Date: Nov. 13, 2025

(54) DISPLAY PANEL AND DISPLAY APPARATUS

(71) Applicants: Wuhan Tianma Microelectronics Co., Ltd., Wuhan (CN); Hubei Yangtze Industrial Innovation Center of Advanced Display Co., Ltd., Wuhan (CN)

(72) Inventors: Shuiqin SHUAI, Wuhan (CN); Yu CAI, Wuhan (CN)

(73) Assignees: Wuhan Tianma Microelectronics Co., Ltd., Wuhan (CN); Hubei Yangtze Industrial Innovation Center Of Advanced Display Co., Ltd., Wuhan (CN)

(21) Appl. No.: 19/272,106

(22) Filed: Jul. 17, 2025

(30) Foreign Application Priority Data
Apr. 24, 2025 (CN) 202510525415.9

(51) Int. Cl. G06F 3/044; G06F 3/046

(52) U.S. Cl. CPC G06F 3/0445; G06F 3/0446; G06F 3/046; G06F 2203/04106; G06F 2203/04114

(57) ABSTRACT

Provided are a display panel and a display apparatus. The touch layer includes a capacitive touch unit including a first capacitor electrode and a second capacitor electrode whose extension directions intersect and an electromagnetic touch unit including a first electromagnetic electrode and a second electromagnetic electrode whose extension directions intersect. At least one of the first electromagnetic electrode and the second electromagnetic electrode is disposed in a different layer from the first capacitor electrode or the second capacitor electrode. Two adjacent first capacitor electrodes are electrically connected through at least one first capacitor connecting portion, and two adjacent second capacitor electrodes are electrically connected through at least one second capacitor connecting portion. The first electromagnetic connecting portion or the second electromagnetic connecting portion is disposed in a same layer as one of the first capacitor connecting portion and the second capacitor connecting portion.

### CROSS-REFERENCE TO RELATED APPLICATION

The present application claims priority to Chinese Patent Application No. 202510525415.9, filed on Apr. 24, 2025, the content of which is incorporated herein by reference in its entirety.

### TECHNICAL FIELD

The present disclosure relates to the field of display technologies and, in particular, to a display panel and a display apparatus.

### BACKGROUND

At present, touch display panels mainly support two modes: finger touch and stylus touch. The display panel that supports stylus touch is mainly realized by attaching the Electro Magnetic Resonance (EMR) module externally to the back of the display panel. When the stylus moves on the display screen, the electromagnetic coils of the EMR module communicates electromagnetically with the stylus, and the coordinates of the stylus are determined by calculating the electromagnetic signals of the electromagnetic coils in different channels.

Due to the inherent thickness of the EMR module, attaching it externally can increase the thickness of the display module, which is not conducive to a thin screen.

### SUMMARY

In view of the above, embodiments of the present disclosure provides a display panel and a display apparatus to enable the display panel to support finger touch and stylus touch, and to reduce the thickness of the display panel and the manufacturing cost of the display panel.

In a first aspect, the present disclosure provides a display panel, including: a substrate; and a touch layer located above a side of the substrate. In an embodiment, the touch layer includes a capacitive touch unit and an electromagnetic touch unit. The capacitive touch unit is configured to sense a first input operation, and the electromagnetic touch unit is configured to sense a second input operation. In an embodiment, the capacitive touch unit includes a first capacitor electrode and a second capacitor electrode whose extension directions intersect with each other, and the electromagnetic touch unit includes a first electromagnetic electrode and a second electromagnetic electrode whose extension directions intersect with each other. In an embodiment, at least one of the first electromagnetic electrode and the second electromagnetic electrode is arranged in a different layer from the first capacitor electrode, or at least one of the first electromagnetic electrode and the second electromagnetic electrode is arranged in a different layer from the second capacitor electrode. In an embodiment, the capacitive touch unit further includes capacitor connecting portions, and the capacitor connecting portions includes a first capacitor connecting portion and a second capacitor connecting portion. In an embodiment, two adjacent first capacitor electrodes are electrically connected to each other through at least one first capacitor connecting portion, and two adjacent second capacitor electrodes are electrically connected to each other through at least one second capacitor connecting portion. In an embodiment, the electromagnetic touch unit further includes electromagnetic connecting portions, and the electromagnetic connecting portions includes a first electromagnetic connecting portion and a second electromagnetic connecting portion. In an embodiment, two adjacent first electromagnetic electrodes are electrically connected to each other through at least one first electromagnetic connecting portion, and two adjacent second electromagnetic electrodes are electrically connected to each other through at least one second electromagnetic connecting portion. In an embodiment, the first electromagnetic connecting portion is arranged in a same layer as one of the first capacitor connecting portion and the second capacitor connecting portion, or the second electromagnetic connecting portion is arranged in a same layer as one of the first capacitor connecting portion and the second capacitor connecting portion.

In a second aspect, the present disclosure provides a display apparatus, including the above display panel.

### BRIEF DESCRIPTION OF DRAWINGS

To clearly illustrate the technical solutions of the embodiments of the present disclosure, the drawings are briefly introduced below. It is appreciated that the drawings described below are only some embodiments of the present disclosure. For those skilled in the art, other drawings can be obtained according to these drawings without any creative effort.

FIG. 1 is a schematic top view of a display panel according to embodiments of the present disclosure;

FIG. 2 is an enlarged schematic diagram of an area A1 in FIG. 1 according to embodiments of the present disclosure;

FIG. 3 is a schematic cross-sectional view along BB′ in FIG. 2 according to embodiments of the present disclosure;

FIG. 4 is a schematic cross-sectional view along CC′ in FIG. 2 according to embodiments of the present disclosure;

FIG. 5 is a schematic top view of a first touch metal layer in FIG. 2 according to embodiments of the present disclosure;

FIG. 6 is a schematic top view of a second touch metal layer in FIG. 2 according to embodiments of the present disclosure;

FIG. 7 is a schematic top view of a third touch metal layer in FIG. 2 according to embodiments of the present disclosure;

FIG. 8 is another enlarged schematic diagram of an area A1 in FIG. 1 according to embodiments of the present disclosure;

FIG. 9 is a schematic top view of a first touch metal layer in FIG. 8 according to embodiments of the present disclosure;

FIG. 10 is a schematic top view of a second touch metal layer in FIG. 8 according to embodiments of the present disclosure;

FIG. 11 is a schematic top view of a third touch metal layer in FIG. 8 according to embodiments of the present disclosure;

FIG. 12 is a schematic cross-sectional view along DD′ in FIG. 8 according to embodiments of the present disclosure;

FIG. 13 is a schematic cross-sectional view along EE′ in FIG. 8 according to embodiments of the present disclosure;

FIG. 14 is another enlarged schematic diagram of an area A1 in FIG. 1 according to embodiments of the present disclosure;

FIG. 15 is a schematic top view of a first touch metal layer in FIG. 14 according to embodiments of the present disclosure;

FIG. 16 is a schematic top view of a second touch metal layer in FIG. 14 according to embodiments of the present disclosure;

FIG. 17 is a schematic top view of a third touch metal layer in FIG. 14 according to embodiments of the present disclosure;

FIG. 18 is a schematic cross-sectional view along FF′ in FIG. 14 according to embodiments of the present disclosure;

FIG. 19 is a schematic cross-sectional view along GG′ in FIG. 14 according to embodiments of the present disclosure;

FIG. 20 is a schematic top view of another display panel according to some embodiments of the present disclosure according to embodiments of the present disclosure;

FIG. 21 is a schematic top view of another display panel according to some embodiments of the present disclosure according to embodiments of the present disclosure;

FIG. 22 is a schematic diagram of a display panel shown in FIG. 21 during an electromagnetic induction stage according to embodiments of the present disclosure;

FIG. 23 is a schematic top view of another display panel according to embodiments of the present disclosure;

FIG. 24 is a schematic diagram of another display panel according to embodiments of the present disclosure;

FIG. 25 is a schematic diagram of another display panel according to embodiments of the present disclosure;

FIG. 26 is a schematic cross-sectional view of another display panel according to embodiments of the present disclosure;

FIG. 27 is a schematic diagram of an electromagnetic touch unit according to embodiments of the present disclosure;

FIG. 28 is an enlarged schematic diagram of an area A2 in FIG. 27 according to embodiments of the present disclosure;

FIG. 29 is a schematic diagram of a first electromagnetic electrode and a pixel opening according to embodiments of the present disclosure; and

FIG. 30 is a schematic diagram of a display apparatus according to embodiments of the present disclosure.

### DESCRIPTION OF EMBODIMENTS

To better understand the technical solutions of the present disclosure, embodiments of the present disclosure are described in detail below in conjunction with the drawings.

It should be understood that the described embodiments are only some, rather than all, of embodiments of the present disclosure. According to embodiments of the present disclosure, all other embodiments obtained by those skilled in the art without any creative effort shall fall within the protection scope of the present disclosure.

The terms used in the embodiments of the present disclosure are only for the purpose of describing specific embodiments and are not intended to limit the present disclosure. The singular forms “a/an”, “said” and “the” used in the embodiments of the present disclosure and the claims are intended to include plural forms unless the context clearly indicates otherwise.

It should be understood that the term “and/or” herein is only used to describe the associated relationship of associated objects, indicating that three relationships may exist. For example, A and/or B can represent: A exists alone, A and B exist at the same time, and B exists alone. In addition, the character “/” herein generally indicates that the associated objects are in an “or” relationship.

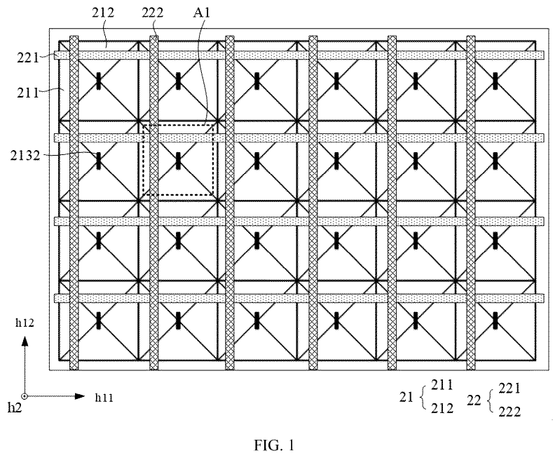

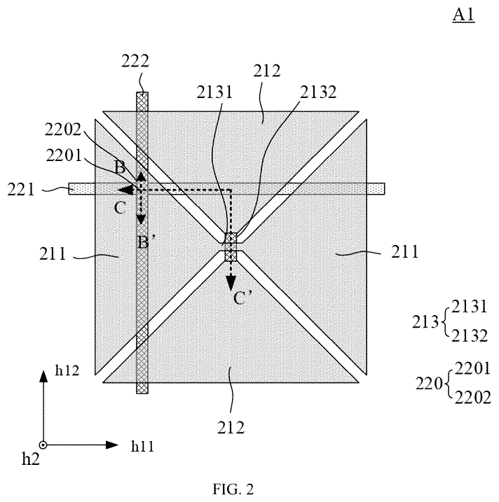

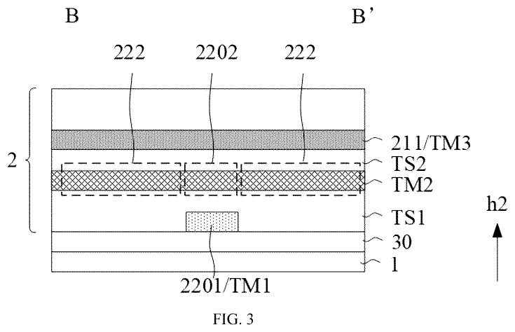

An embodiment of the present disclosure provides a display panel. As shown in FIGS. 1 to 3, where FIG. 1 is a schematic top view of a display panel according to some embodiments of the present disclosure, FIG. 2 is an enlarged schematic diagram of an area A1 in FIG. 1, and FIG. 3 is a cross-sectional schematic view along BB′ in FIG. 2, the display panel includes a substrate 1 and a touch layer 2 located above a side of the substrate 1. The touch layer 2 includes a capacitive touch unit 21 and an electromagnetic touch unit 22. The capacitive touch unit 21 is configured to sense a first input operation, and the electromagnetic touch unit 22 is configured to sense a second input operation. The first input operation includes a finger touch operation on the display panel. The second input operation includes a stylus touch operation on the display panel. The stylus can emit electromagnetic waves, and has structures such as an RC resonant circuit, a pressure-sensitive capacitor, and a coil.

For example, as shown in FIG. 3, the display panel further includes a display film layer 30 in which sub-pixels (not shown) are provided. The touch layer 2 is located above a side of the display film layer 30 away from the substrate 1.

In the embodiment of the present disclosure, it is possible to avoid attaching the electromagnetic touch unit 22 externally to the side of the display panel away from the light-emitting side by integrating the capacitive touch unit 21 and the electromagnetic touch unit 22 into the touch layer 2, which can reduce the thickness of the display panel. In addition, it is possible to avoid setting up separate assembly stations in the manufacturing process to align and attach the electromagnetic touch unit 22 and the display panel, which is beneficial to reducing the manufacturing processes of the display panel and reducing the manufacturing cost of the display panel.

For example, as shown in FIG. 1, in some embodiments of the present disclosure, the capacitive touch unit 21 can be configured to include a first capacitive electrode 211 and a second capacitive electrode 212 whose extension directions intersect with each other. FIG. 1 schematically shows that the first capacitor electrode 211 extends along a first direction h11 and the second capacitor electrode 212 extends along a second direction h12, and the first direction h11 and the second direction h12 intersect with each other. For example, one of the first capacitor electrode 211 and the second capacitor electrode 212 transmits a touch driving signal, and the other one transmits a touch sensing signal.

As shown in FIG. 1, the electromagnetic touch unit 22 includes a first electromagnetic electrode 221 and a second electromagnetic electrode 222 whose extension directions intersect with each other. FIG. 1 and FIG. 2 schematically show that the first electromagnetic electrode 221 extends along the first direction h11 and the second electromagnetic electrode 222 extends along the second direction h12. The first electromagnetic electrode 221 is configured to form a first electromagnetic coil, and the second electromagnetic electrode 222 is configured to form a second electromagnetic coil.

In some embodiments of the present disclosure, at least one of the first electromagnetic electrode 221 and the second electromagnetic electrode 222 is arranged in a different layer from the first capacitor electrode 211, or at least one of the first electromagnetic electrode 221 and the second electromagnetic electrode 222 is arranged in a different layer from the second capacitor electrode 212. That is, the first electromagnetic electrode 221 and the first capacitor electrode 211 are arranged in different layers, or the second electromagnetic electrode 222 and the first capacitor electrode 211 are arranged in different layers, or the first electromagnetic electrode 221 and the second electromagnetic electrode 222 are both arranged in a different layer from the first capacitor electrode 211; or the first electromagnetic electrode 221 and the second capacitor electrode 212 are arranged in different layers, or the second electromagnetic electrode 222 and the second capacitor electrode 212 are arranged in different layers, or the first electromagnetic electrode 221 and the second electromagnetic electrode 222 are both arranged in a different layer from the second capacitor electrode 212.

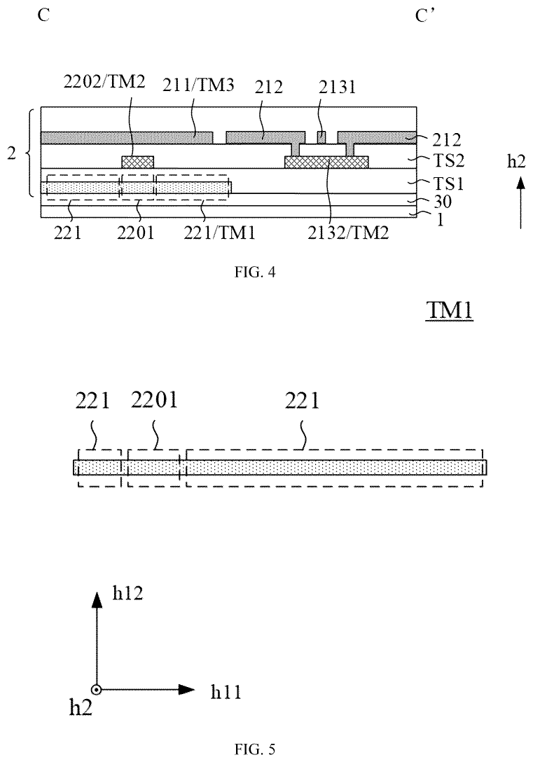

As shown in FIG. 2, FIG. 3 and FIG. 4, where FIG. 4 is a schematic cross-sectional view along CC′ in FIG. 2, the touch layer 2 includes a first touch metal layer TM1, a second touch metal layer TM2, a third touch metal layer TM3, a first touch insulating layer TS1 arranged between the first touch metal layer TM1 and the second touch metal layer TM2, and a second touch insulating layer TS2 arranged between the second touch metal layer TM2 and the third touch metal layer TM3.

In some embodiments of the present disclosure, the first electromagnetic electrode 221 can be arranged in the first touch metal layer TM1, the second electromagnetic electrode can be arranged in the second touch metal layer TM2, and the first capacitor electrode 211 and the second capacitor electrode 212 can be arranged in the third touch metal layer TM3.

Based on this setting method, it is possible to avoid the first electromagnetic electrode 221 or the second electromagnetic electrode 222 occupying the position of the first capacitor electrode 211, thereby ensuring the area of the first capacitor electrode 211. Alternatively, it is possible to avoid the first electromagnetic electrode 221 or the second electromagnetic electrode 222 occupying the position of the second capacitor electrode 212, thereby ensuring the area of the second capacitor electrode 212. In this way, the mutual influence between electromagnetic touch and capacitive touch can be reduced, so that the effect of capacitive touch is similar or the same as that when the electromagnetic touch unit 22 is not provided in the display panel, and the effect of electromagnetic touch is similar or the same as that when the capacitive touch unit 21 is not provided in the display panel.

For example, the first touch metal layer TM1, the second touch metal layer TM2 and the third touch metal layer TM3 include metal materials such as molybdenum metal, molybdenum alloy, aluminum metal, aluminum alloy, copper metal, copper alloy, titanium metal or titanium alloy. For example, in some embodiments of the present disclosure, at least one of the first touch metal layer TM1, the second touch metal layer TM2 and the third touch metal layer TM3 can be configured to include a titanium-aluminum-titanium stacked structure.

In some embodiments of the present disclosure, the first capacitor electrode 211 and the second capacitor electrode 212 at least partially do not overlap along the direction h2 perpendicular to a plane of the substrate, and the two can be arranged in the same layer or in different layers. The first electromagnetic electrode 221 and the second electromagnetic electrode 222 at least partially do not overlap along the direction h2 perpendicular to the plane of the display panel, and the two can be arranged in the same layer or in different layers. FIG. 2 schematically shows that the first capacitor electrode 211 and the second capacitor electrode 212 are arranged together in the third touch metal layer TM3, and the first electromagnetic electrode 221 and the second electromagnetic electrode 222 are arranged in different layers.

For example, as shown in FIG. 2, the capacitive touch unit 21 further includes capacitor connecting portions 213. The capacitor connecting portions 213 includes a first capacitor connecting portion 2131 and a second capacitor connecting portion 2132. Two adjacent first capacitor electrodes 211 in the first direction h11 are electrically connected to each other through at least one first capacitor connecting portion 2131, and two adjacent second capacitor electrodes 212 in the second direction h12 are electrically connected to each other through at least one second capacitor connecting portion 2132. FIG. 2 schematically shows that two adjacent first capacitor electrodes 211 in the first direction h11 are electrically connected to each other through one first capacitor connecting portion 2131, and two adjacent second capacitor electrodes 212 in the second direction h12 are electrically connected to each other through one second capacitor connecting portion 2132.

In some embodiments of the present disclosure, the first capacitor connecting portion 2131 and the second capacitor connecting portion 2132 at least partially overlap in the direction h2 perpendicular to the plane of the substrate, and the two are arranged in different layers. For example, the first capacitor connecting portion 2131 may be arranged in one of the first touch metal layer TM1, the second touch metal layer TM2 and the third touch metal layer TM3, and the second capacitor connecting portion 2132 may be arranged in any of the other two layers of the first touch metal layer TM1, the second touch metal layer TM2 and the third touch metal layer TM3. FIG. 2 and FIG. 4 schematically show that the first capacitor connecting portion 2131 is arranged in the third touch metal layer TM3 and the second capacitor connecting portion 2132 is arranged in the second touch metal layer TM2.

Referring to FIG. 2, the electromagnetic touch unit 22 further includes electromagnetic connecting portions 220. The electromagnetic connecting portions 220 include a first electromagnetic connecting portion 2201 and a second electromagnetic connecting portion 2202. Two adjacent first electromagnetic electrodes 221 are electrically connected to each other through at least one first electromagnetic connecting portion 2201, and two adjacent second electromagnetic electrodes 222 are electrically connected to each other through at least one second electromagnetic connecting portion 2202.

In some embodiments of the present disclosure, the first electromagnetic connecting portion 2201 and the second electromagnetic connecting portion 2202 at least partially overlap in the direction h2 perpendicular to the plane of the substrate, and the two are arranged in different layers. For example, the first electromagnetic connecting portion 2201 may be arranged in one of the first touch metal layer TM1, the second touch metal layer TM2 and the third touch metal layer TM3, and the second electromagnetic connecting portion 2202 may be arranged in any of the other two layers of the first touch metal layer TM1, the second touch metal layer TM2 and the third touch metal layer TM3. FIG. 2, FIG. 3 and FIG. 4 schematically show that the first electromagnetic connecting portion 2201 is arranged in the first touch metal layer TM1 and the second electromagnetic connecting portion 2202 is arranged in the second touch metal layer TM2.

In some embodiments of the present disclosure, the first electromagnetic connecting portion 2201 is arranged in the same layer as one of the first capacitor connecting portion 2131 and the second capacitor connecting portion 2132, or the second electromagnetic connecting portion 2202 is arranged in the same layer as one of the first capacitor connecting portion 2131 and the second capacitor connecting portion 2132. Based on this setting method, when manufacturing the display panel, the first electromagnetic connecting portion 2201 and one of the first capacitor connecting portion 2131 and the second capacitor connecting portion 2132 can be formed simultaneously in the same patterning process, or the second electromagnetic connecting portion 2202 and one of the first capacitor connecting portion 2131 and the second capacitor connecting portion 2132 can be formed simultaneously in the same patterning process, which is beneficial to simplifying the manufacturing process of the display panel and further reducing the thickness of the display panel.

FIG. 4 schematically shows that the second electromagnetic connecting portion 2202 and the second capacitor connecting portion 2132 are arranged together in the second touch metal layer TM2.

In some embodiments of the present disclosure, as shown in FIG. 2, any one of the capacitor connecting portions 213 and any one of the electromagnetic connecting portions 220 are arranged staggered along the direction h2 perpendicular to the plane of the substrate 1. That is, along the direction h2 perpendicular to the plane of the substrate 1, the first capacitor connecting portion 2131 and the first electromagnetic connecting portion 2201 are arranged staggered, the first capacitor connecting portion 2131 and the second electromagnetic connecting portion 2202 are arranged staggered, the second capacitor connecting portion 2132 and the first electromagnetic connecting portion 2201 are arranged staggered, and the second capacitor connecting portion 2132 and the second electromagnetic connecting portion 2202 are arranged staggered. Based on this setting method, while ensuring that any one of the capacitor connecting portions 213 and any one of the electromagnetic connecting portions 220 are insulated from each other, the first electromagnetic connecting portion 2201 can be arranged in the same layer as one of the first capacitor connecting portion 2131 and the second capacitor connecting portion 2132, or the second electromagnetic connecting portion 2202 can be arranged in the same layer as one of the first capacitor connecting portion 2131 and the second capacitor connecting portion 2132, so as to reduce the thickness of the display panel and simplify the manufacturing process of the display panel.

For example, in some embodiments of the present disclosure, the first electromagnetic connecting portion 2201 and the second electromagnetic connecting portion 2202 can be arranged in different layers, the first electromagnetic electrode 221 and the first electromagnetic connecting portion 2201 can be arranged in the same layer, and the second electromagnetic electrode 222 and the second electromagnetic connecting portion 2202 can be arranged in the same layer.

As shown in FIG. 2 and FIG. 5, where FIG. 5 is a schematic top view of a first touch metal layer in FIG. 2, the first electromagnetic electrode 221 and the first electromagnetic connecting portion 2201 can be arranged together in the first touch metal layer TM1.

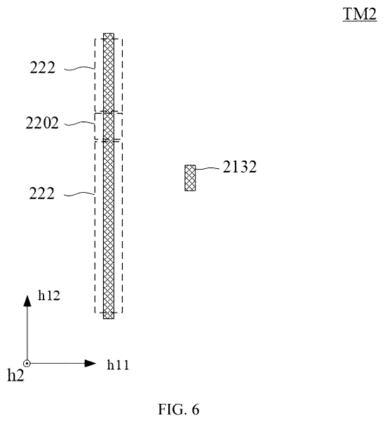

As shown in FIG. 2 and FIG. 6, where FIG. 6 is a schematic top view of a second touch metal layer in FIG. 2, the second electromagnetic electrode 222 and the second electromagnetic connecting portion 2202 can be arranged together in the second touch metal layer TM2.

It should be noted that when the first electromagnetic electrode 221 and the first electromagnetic connecting portion 2201 are arranged in the same layer, the two can be regarded as two parts located in different areas of a whole, that is, there is no interface between the two. When the second electromagnetic electrode 222 and the second electromagnetic connecting portion 2202 are arranged in the same layer, the two can be regarded as two parts located in different areas of a whole, that is, there is no interface between the two.

When the touch layer 2 is configured to include the first touch metal layer TM1, the second touch metal layer TM2 and the third touch metal layer TM3 as shown in FIG. 3 and FIG. 4, in some embodiments of the present disclosure, the first touch metal layer TM1 may include one of the first electromagnetic electrode 221 and the second electromagnetic electrode 222, and the second touch metal layer TM2 may include the other of the first electromagnetic electrode 221 and the second electromagnetic electrode 222, and the second capacitor connecting portion 2132. FIG. 2 and FIG. 5 schematically show that the first touch metal layer TM1 includes the first electromagnetic electrode 221 and the first electromagnetic connecting portion 2201, and FIG. 2 and FIG. 6 schematically show that the second touch metal layer TM2 includes the second electromagnetic electrode 222, the second electromagnetic connecting portion 2202 and the second capacitor connecting portion 2132.

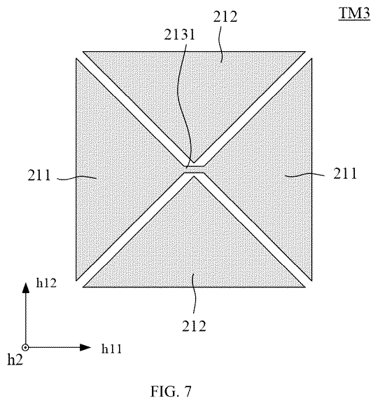

As shown in FIG. 2 and FIG. 7, where FIG. 7 is a schematic top view of a third touch metal layer in FIG. 2, in some embodiments of the present disclosure, the third touch metal layer TM3 may include the first capacitor electrode 211, the first capacitor connecting portion 2131 and the second capacitor electrode 212.

In some other embodiments of the present disclosure, the second electromagnetic electrode 222 and the second electromagnetic connecting portion 2202 can be arranged in different layers, and the first electromagnetic electrode 221, the first electromagnetic connecting portion 2201 and the second electromagnetic electrode 222 can be arranged in the same layer.

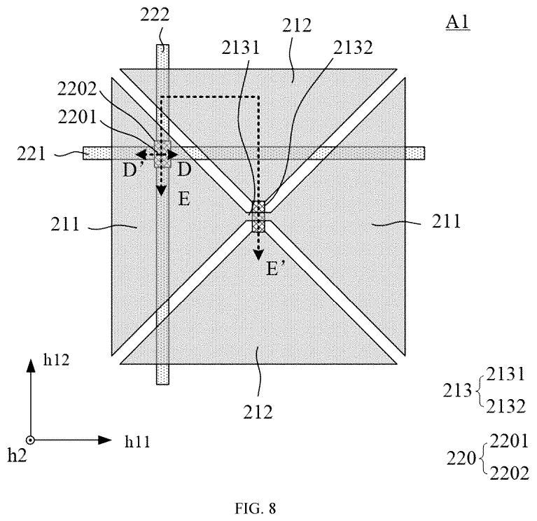

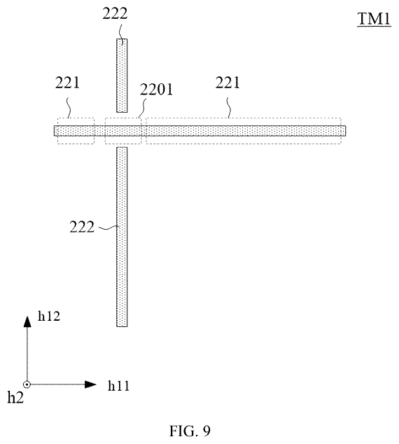

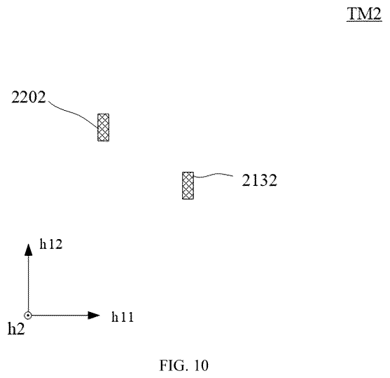

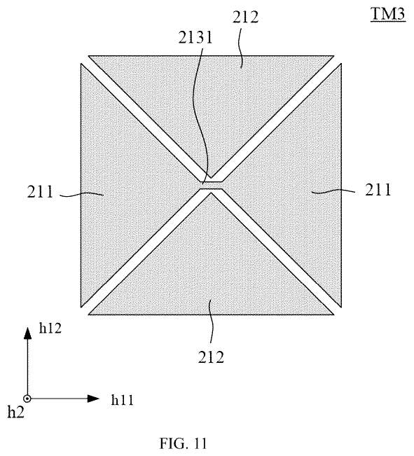

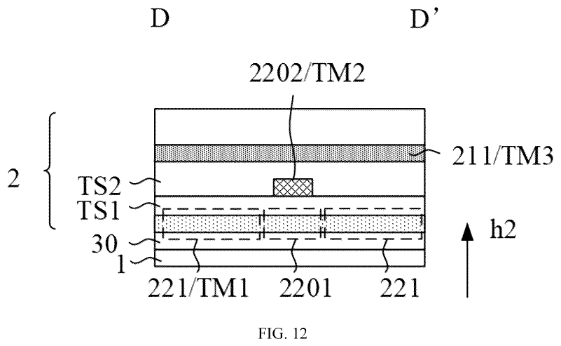

As shown in FIG. 8, FIG. 9, FIG. 10, FIG. 11 and FIG. 12, where FIG. 8 is another enlarged schematic diagram of an area A1 in FIG. 1, FIG. 9 is a schematic top view of a first touch metal layer in FIG. 8, FIG. 10 is a schematic top view of a second touch metal layer in FIG. 8, FIG. 11 is a schematic top view of a third touch metal layer in FIG. 8, and FIG. 12 is a schematic cross-sectional view along DD′ in FIG. 8, the first touch metal layer TM1 includes the first electromagnetic electrode 221, the first electromagnetic connecting portion 2201 and the second electromagnetic electrode 222, the second touch metal layer TM2 includes the second capacitor connecting portion 2132 and the second electromagnetic connecting portion 2202, and the third touch metal layer TM3 includes the first capacitor electrode 211, the second capacitor electrode 212 and the first capacitor connecting portion 2131.

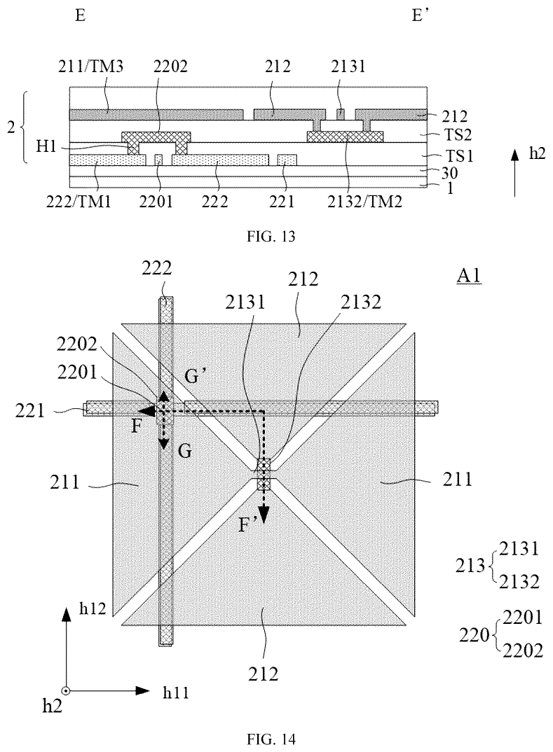

As shown in FIG. 8 and FIG. 13, where FIG. 13 is a schematic cross-sectional view along EE′ in FIG. 8, the first touch insulating layer TS1 includes a first via H1, and the second electromagnetic connecting portion 2202 arranged in the second touch metal layer TM2 is electrically connected to the second electromagnetic electrode 222 arranged in the first touch metal layer TM1 through the first via H1.

In some other embodiments of the present disclosure, the first electromagnetic electrode 221 can include a first structure and a second structure arranged in a stacked manner and electrically connected to each other, and/or the second electromagnetic electrode 222 also include a first structure and a second structure arranged in a stacked manner and electrically connected to each other. The first structure and the second structure of the first electromagnetic electrode are actually arranged in parallel, which can reduce the resistance of the first electromagnetic electrode 221. The first structure and the second structure of the second electromagnetic electrode 222 are actually arranged in parallel, which can reduce the resistance of the second electromagnetic electrode 222.

For example, one of the first structure and the second structure is arranged in the same layer as the first electromagnetic connecting portion 2201, and the other of the first structure and the second structure is arranged in the same layer as the second electromagnetic connecting portion 2202.

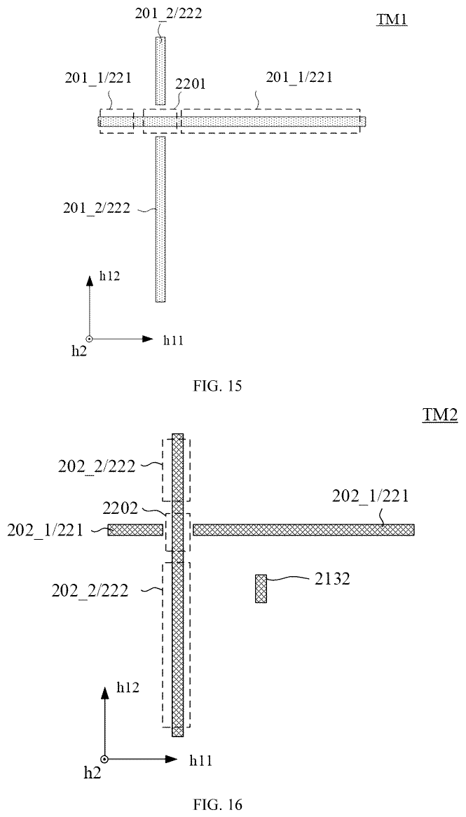

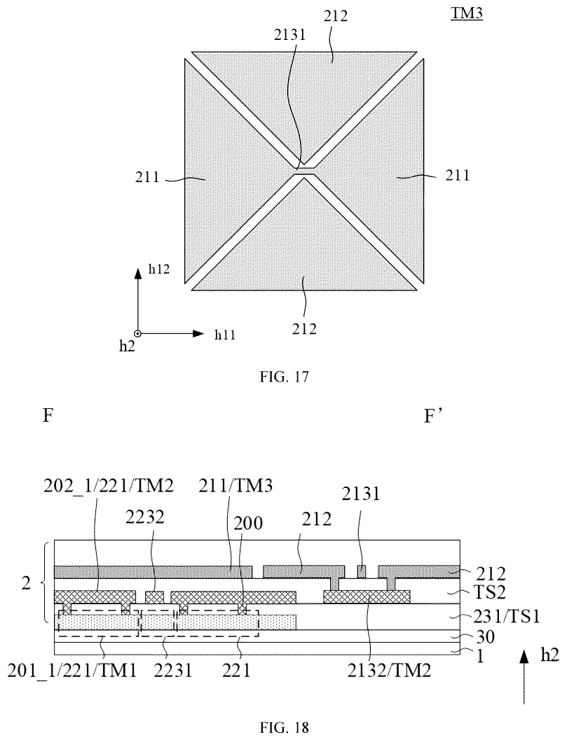

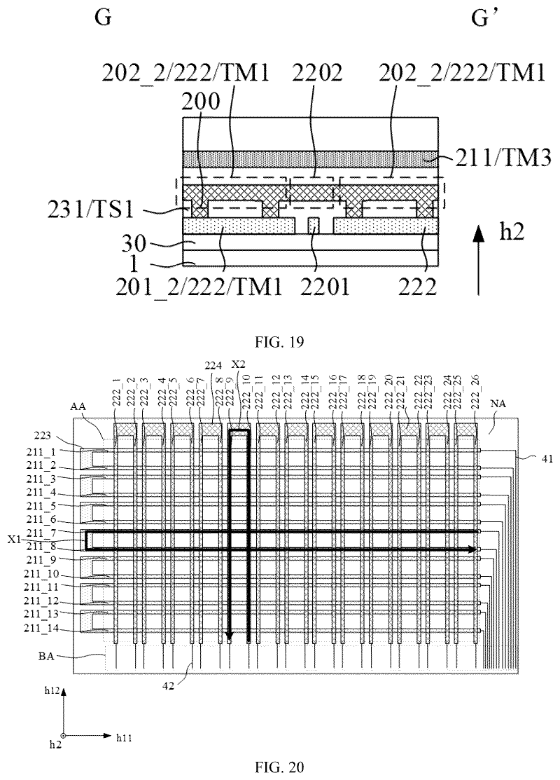

For example, as shown in FIG. 14, FIG. 15, FIG. 16, FIG. 17, FIG. 18 and FIG. 19, where FIG. 14 is another enlarged schematic diagram of an area A1 in FIG. 1, FIG. 15 is a schematic top view of a first touch metal layer in FIG. 14, FIG. 16 is a schematic top view of a second touch metal layer in FIG. 14, FIG. 17 is a schematic top view of a third touch metal layer in FIG. 14, FIG. 18 is a schematic cross-sectional view along FF′ in FIG. 14, and FIG. 19 is a schematic cross-sectional view along GG′ in FIG. 14, FIG. 15 schematically shows that the first structure 201_1 of the first electromagnetic electrode 221, the first structure 201_2 of the second electromagnetic electrode 222 and the first electromagnetic connecting portion 2201 are arranged together in the first touch metal layer TM1, and FIG. 16 schematically shows that the second structure 202_1 of the first electromagnetic electrode 221, the second structure 202_2 of the second electromagnetic electrode 222 and the second electromagnetic connecting portion 2202 are arranged together in the second touch metal layer TM2.

As shown in FIG. 18 and FIG. 19, the display panel further includes a first insulating layer 231 arranged between the first structure 201 and the second structure 202, and the first insulating layer 231 includes a via 200.

It should be noted that when the first structure 201 is arranged in the first touch insulating layer TS1 and the second structure 202 is arranged in the second touch insulating layer TS2, the first insulating layer 231 is the first touch insulating layer TS1.

As shown in FIG. 18, the first structure 201_1 and the second structure 202_1 of the first electromagnetic electrode 221 are electrically connected to each other through at least two vias 200. As shown in FIG. 19, the first structure 201_2 and the second structure 202_2 of the second electromagnetic electrode 222 are electrically connected to each other through at least two vias 200.

In some embodiments of the present disclosure, the first touch metal layer TM1 or the second touch metal layer TM2 includes the second capacitor connecting portion 2132. FIG. 14 and FIG. 16 schematically show that the second touch metal layer TM2 includes the second capacitor connecting portion 2132.

As shown in FIG. 17, the third touch metal layer TM3 includes the first capacitor electrode 211, the second capacitor electrode 212 and the first capacitor connecting portion 2131.

For example, an organic insulating layer is arranged between any two adjacent ones of the first touch metal layer TM1, the second touch metal layer TM2 and the third touch metal layer TM3. That is, the first touch insulating layer TS1 and the second touch insulating layer TS2 shown in FIG. 3, FIG. 4, FIG. 12, FIG. 13, FIG. 18 and FIG. 19 are organic insulating layers having organic materials. Compared with inorganic materials, organic materials have good bending properties. Therefore, based on this setting method, the bending performance of the display panel can be improved, and the bending reliability of the display panel can be improved when the display panel is used in a folding display apparatus.

For example, the organic insulating layer includes any one or more of polyethersulfone (PES), polyacrylate, polyetherimide (PEI), polyethylene naphthalate (PEN), polyethylene terephthalate (PET), polyphenylene sulfide (PPS), polyarylester (PAR), polyimide (PI), polycarbonate (PC), and cellulose acetate propionate (CAP).

It should be noted that the arrangement of the first touch metal layer TM1, the second touch metal layer TM2 and the third touch metal layer TM3 from bottom to top in FIG. 3, FIG. 4, FIG. 12, FIG. 13, FIG. 18 and FIG. 19 is only for illustration, and the order may be changed according to different design requirements, which are not limited thereto in the present disclosure.

In some embodiments of the present disclosure, as shown in FIG. 20, which is a schematic top view of another display panel according to some embodiments of the present disclosure, the display panel further includes a display area AA and a non-display area NA. The display area includes a plurality of sub-pixels (not shown in FIG. 1), so that the display area AA can display images.

In some embodiments of the present disclosure, the first capacitor electrode, the second capacitor electrode, the first electromagnetic electrode and the second electromagnetic electrode are at least partially located in the display area AA. To clearly illustrate the first electromagnetic electrode 221 and the second electromagnetic electrode 222, the first capacitor electrode and the second capacitor electrode are omitted in FIG. 20.

As shown in FIG. 20, the non-display area NA includes a third electromagnetic electrode 223 and a fourth electromagnetic electrode 224. The third electromagnetic electrode 223 is electrically connected to one end of at least two first electromagnetic electrodes 221, and the fourth electromagnetic electrode 224 is electrically connected to one end of at least two second electromagnetic electrodes 222. FIG. 20 schematically shows that the third electromagnetic electrode 223 is electrically connected to one end of two first electromagnetic electrodes 221, and the fourth electromagnetic electrode 224 is electrically connected to one end of two second electromagnetic electrodes 222.

During the operation of the electromagnetic touch unit, the third electromagnetic electrode 223 is connected to two first electromagnetic electrodes 221 to form a first electromagnetic coil, and the current can flow in the first electromagnetic coil to form a loop. FIG. 20 shows the flow direction of the current in one first electromagnetic coil with a first arrow X1. The fourth electromagnetic electrode 224 is connected to two second electromagnetic electrodes 222 to form a second electromagnetic coil, and the current can flow in the second electromagnetic coil to form a loop. FIG. 20 shows the flow direction of the current in one second electromagnetic coil with a second arrow X2.

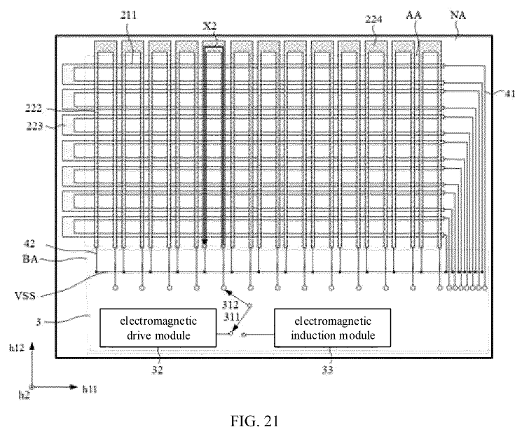

For example, as shown in FIG. 21, which is a schematic top view of another display panel according to some embodiments of the present disclosure, the display panel further includes an electromagnetic control circuit 3. The electromagnetic control circuit 3 is electrically connected to the other end of the first electromagnetic electrode 221 or the other end of the second electromagnetic electrode 222. The other end of the first electromagnetic electrode 221 refers to the end of the first electromagnetic electrode 221 that is not connected to the third electromagnetic electrode 223, and the other end of the second electromagnetic electrode 222 refers to the end of the second electromagnetic electrode 222 that is not connected to the fourth electromagnetic electrode 224.

For example, as shown in FIG. 21, the electromagnetic control circuit 3 includes a first switch 311, an electromagnetic drive module 32 and an electromagnetic induction module 33.

In some embodiments of the present disclosure, an electromagnetic touch process of the display panel includes an electromagnetic drive stage and an electromagnetic induction stage. During the electromagnetic drive stage, as shown in FIG. 21, the first switch 311 is electrically connected to the electromagnetic drive module 32 and one of the first electromagnetic electrode 221 and the second electromagnetic electrode 222. The electromagnetic driving signal generated by the electromagnetic driving module 32 can be transmitted in the first electromagnetic coil formed by the third electromagnetic electrode 223 and two first electromagnetic electrodes 221, or in the second electromagnetic coil formed by the fourth electromagnetic electrode 224 and two second electromagnetic electrodes 222. The electromagnetic driving signal includes an alternating current, and the frequency thereof can correspond to the resonant frequency of the stylus. When the stylus touches the display panel, the oscillation circuit of the stylus senses the change in the magnetic field and generates a feedback signal with a specific frequency.

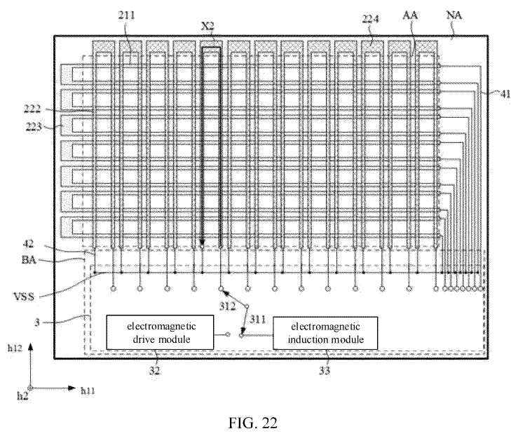

During the electromagnetic induction stage, as shown in FIG. 22, which is a schematic diagram of a display panel shown in FIG. 21 during an electromagnetic induction stage, the first switch 311 switches from the state shown in FIG. 21 to be electrically connected to the electromagnetic induction module 33 and one of the first electromagnetic electrode 221 and the second electromagnetic electrode 222. The electrical signal in the first electromagnetic coil formed by the third electromagnetic electrode 223 and two first electromagnetic electrodes 221 can be transmitted to the electromagnetic induction module 33, or the electrical signal in the second electromagnetic coil formed by the fourth electromagnetic electrode 224 and two second electromagnetic electrodes 222 can be transmitted to the electromagnetic induction module 33. The electromagnetic induction module 33 can receive the signal with a specific frequency emitted by the first electromagnetic coil or the second electromagnetic coil, and determines the coordinates of the stylus by calculation according to the electromagnetic signals in different channels. The first electromagnetic coil formed by the first electromagnetic electrode 221 can be configured to determine the coordinates of the stylus in the first direction h11, and the second electromagnetic coil formed by the second electromagnetic electrode 222 can be configured to determine the coordinates of the stylus in the second direction h12.

For example, as shown in FIG. 20, FIG. 21 and FIG. 22, in some embodiments of the present disclosure, two adjacent second electromagnetic electrodes 222 in the first direction h11 can form the second electromagnetic coil, and two adjacent first electromagnetic electrodes 221 in the second direction h12 can form the first electromagnetic coil.

For example, as shown in FIG. 21 and FIG. 22, the electromagnetic control circuit 3 further includes a second switch 312. In the two second electromagnetic electrodes 222 forming the second electromagnetic coil, an end of one second electromagnetic electrode 222 that is not connected to the fourth electromagnetic electrode 224 is connected to the first switch 311 through the second switch 312, and an end of the other one second electromagnetic electrode 222 that is not connected to the fourth electromagnetic electrode 224 can be connected to a fixed signal end VSS. The current can flow between the second electromagnetic electrode 222 connected to the electromagnetic drive module 32 or the electromagnetic induction module 33, the fourth electromagnetic electrode 224, the second electromagnetic electrode 222 connected to the fixed signal end VSS, and the fixed signal end VSS to form a loop.

When the display panel is electromagnetically touched, the second switch 312 can switch between different second electromagnetic electrodes 222 that are not connected to the fixed signal end VSS, so that the electromagnetic drive module 32 charges different second electromagnetic coils, or electrical signals of different second electromagnetic coils is transmitted to the electromagnetic induction module 33.

For example, as shown in FIG. 21 and FIG. 22, in the two first electromagnetic electrodes forming the first electromagnetic coil, an end of one first electromagnetic electrode 221 that is not connected to the third electromagnetic electrode 223 can be connected to the first switch 311 through the second switch 312, and an end of the other one first electromagnetic electrode 221 that is not connected to the third electromagnetic electrode 223 can be connected to the fixed signal end VSS. The current can flow between the first electromagnetic electrode 221 connected to the electromagnetic drive module 32 or the electromagnetic induction module 33, the third electromagnetic electrode 223, the first electromagnetic electrode 221 connected to the fixed signal end VSS, and the fixed signal end VSS to form a loop.

When the display panel is electromagnetically touched, the second switch 312 can switch between different first electromagnetic electrodes 221 that are not connected to the fixed signal end VSS, so that the electromagnetic drive module 32 charges different first electromagnetic coils, or electrical signals of different first electromagnetic coils is transmitted to the electromagnetic induction module 33.

FIG. 21 and FIG. 22 schematically show the electromagnetic drive module 32 is electrically connected to the second electromagnetic electrode 222 through the first switch 311 and the second switch 312, and the second switch 312 is connected to the first electromagnetic electrode 221 in a similar manner, which is not illustrated herein.

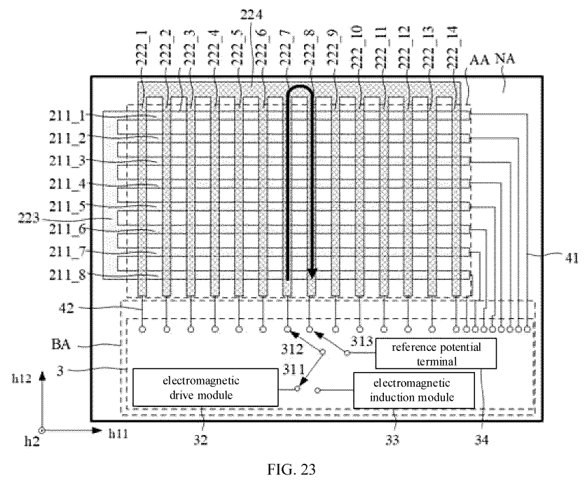

In some other embodiment of the present disclosure, the third electromagnetic electrode 223 can be electrically connected to at least three first electromagnetic electrodes 221, and the fourth electromagnetic electrode 224 can be electrically connected to at least three second electromagnetic electrodes 222. As shown in FIG. 23, which is a schematic diagram of another display panel according to some embodiments of the present disclosure, the third electromagnetic electrode 223 is electrically connected to eight first electromagnetic electrodes, and the eight first electromagnetic electrodes are marked as 221_1, 221_2, . . . , 221_7, 221_8; the fourth electromagnetic electrode 224 is electrically connected to fourteen second electromagnetic electrodes, and the fourteen second electromagnetic electrodes are marked as 222_1, 222_2, . . . , 222_13, 222_14.

As shown in FIG. 23, in addition to the first switch 311 and the second switch 312, the electromagnetic control circuit 3 further includes a third switch 313, one of the first electromagnetic electrodes forming the first electromagnetic coil is electrically connected to the first switch 311 through the second switch 312, and the other of the first electromagnetic electrodes forming the first electromagnetic coil is electrically connected to a reference potential terminal 34 of the electromagnetic control module 3 through the third switch 313. One of the second electromagnetic electrodes 222 forming the second electromagnetic coil is electrically connected to the first switch 311 through the second switch 312, and the other of the second electromagnetic electrodes 222 forming the second electromagnetic coil is electrically connected to the reference potential terminal 34 through the third switch 313.

Based on the setting method shown in FIG. 23, the size and position of the first electromagnetic coil or the second electromagnetic coil can be adjusted by controlling the second switch 312 and the third switch 313 to select different first electromagnetic electrodes 221 or second electromagnetic electrodes 222, which improves the flexibility of the electromagnetic coil.

For example, when the second electromagnetic electrode 222_7 and the second electromagnetic electrode 222_8 need to form the second electromagnetic coil, the second switch 312 is controlled to be electrically connected to the second electromagnetic electrode 222_7, and the third switch 313 is controlled to be electrically connected to the second electromagnetic electrode 222_8. When the second electromagnetic electrode 222_8 and the second electromagnetic electrode 222_9 need to form the second electromagnetic coil, the second switch 312 is controlled to be electrically connected to the second electromagnetic electrode 222_8, and the third switch 313 is controlled to be electrically connected to the second electromagnetic electrode 222_9, which is simple to operate.

In addition, by comparing FIG. 23 with FIG. 20, it can be seen that the display panel shown in FIG. 20 has seven first electromagnetic coils formed by fourteen first electromagnetic electrodes (the fourteen first electromagnetic electrodes are marked as 221_1, 221_2, . . . , 221_13, 221_14, respectively), and thirteen second electromagnetic coils formed by twenty-six second electromagnetic electrodes (the twenty-six second electromagnetic electrodes are marked as 222_1, 222_2, . . . , 222_25, 222_26, respectively).

In the display panel shown in FIG. 23, taking the first electromagnetic coil formed by any two adjacent first electromagnetic electrodes 221 as an example, the display panel shown in FIG. 23 has seven first electromagnetic coils formed by eight first electromagnetic electrodes 221.

The seven first electromagnetic coils are the first electromagnetic coil formed by the first electromagnetic electrode 221_1 and the first electromagnetic electrode 221_2, the first electromagnetic coil formed by the first electromagnetic electrode 221_2 and the first electromagnetic electrode 221_3, the first electromagnetic coil formed by the first electromagnetic electrode 221_3 and the first electromagnetic electrode 221_4, . . . , the first electromagnetic coil formed by the first electromagnetic electrode 221_6 and the first electromagnetic electrode 221_7, and the first electromagnetic coil formed by the first electromagnetic electrode 221_7 and the first electromagnetic electrode 221_8, respectively.

It can be seen that when the method shown in FIG. 23 is adopted, since the third electromagnetic electrode 223 can participate in the formation of the first electromagnetic coil including different first electromagnetic electrodes 221 at different times, when the number of the first electromagnetic coils formed is the same, the number of the first electromagnetic electrodes 221 required can be reduced by the selection of different first electromagnetic electrodes 221 through the second switch 312 and the third switch 313, thereby reducing the number of first traces 41 electrically connected to the first electromagnetic electrodes 221, which is beneficial to reducing the width of the non-display area NA where the first traces 41 are located. In other words, when the number of first electromagnetic electrodes 221 is constant, based on the method of electrically connecting the third electromagnetic electrode 223 to at least three first electromagnetic electrodes 221 as shown in FIG. 23, the number of first electromagnetic coils formed can be increased, thereby improving the reliability of electromagnetic touch.

In addition, taking the second electromagnetic coil formed by any two adjacent second electromagnetic electrodes 222 as an example, the display panel shown in FIG. 23 has thirteen second electromagnetic coils formed by fourteen second electromagnetic electrodes 222. The thirteen second electromagnetic coils are the second electromagnetic coil formed by the second electromagnetic electrode 222_1 and the second electromagnetic electrode 222_2, the second electromagnetic coil formed by the second electromagnetic electrode 222_2 and the second electromagnetic electrode 222_3, the second electromagnetic coil formed by the second electromagnetic electrode 222_3 and the second electromagnetic electrode 222_4, . . . , the second electromagnetic coil formed by the second electromagnetic electrode 222_12 and the second electromagnetic electrode 222_13, and the second electromagnetic coil formed by the second electromagnetic electrode 222_13 and the second electromagnetic electrode 222_14, respectively.

It can be seen that in some embodiments of the present disclosure, the fourth electromagnetic electrode 224 can be electrically connect to at least three second electromagnetic electrodes 222. When the method shown in FIG. 23 is adopted, since the fourth electromagnetic electrode 224 can participate in the formation of the second electromagnetic coil including different second electromagnetic electrodes 222 at different times, when the number of the second electromagnetic coils formed is the same, the number of the second electromagnetic electrodes 222 required can be reduced by the selection of different second electromagnetic electrodes 222 through the second switch 312 and the third switch 313, thereby reducing the number of second traces 42 electrically connected to the second electromagnetic electrodes 222, which is beneficial to reducing the width of the non-display area NA where the second traces 42 are located. In other words, when the number of second electromagnetic electrodes 222 is constant, based on the method of electrically connecting the fourth electromagnetic electrode 224 to at least three second electromagnetic electrodes 222 as shown in FIG. 23, the number of second electromagnetic coils formed can be increased, thereby improving the reliability of electromagnetic touch.

For example, as shown in FIG. 20, FIG. 21, FIG. 22 and FIG. 23, the non-display area NA further includes a plurality of first traces 41 and a plurality of second traces 42, the first trace 41 is electrically connected to the first electromagnetic electrode 221, and the second trace 42 is electrically connected to the second electromagnetic electrode 222.

As shown in FIG. 20, FIG. 21, FIG. 22 and FIG. 23, the non-display area NA includes a binding area BA. In some embodiments of the present disclosure, the binding area BA may be located on a side of the display area AA in the second direction h12. For example, the binding area BA can include a plurality of pads (not shown in FIG. 20, FIG. 21, FIG. 22 and FIG. 23), and the first traces 41 and the second traces 42 can extend to the binding area BA and be bound and connected to the corresponding pads. The second switch 312 and the third switch 313 can be electrically connected to the first electromagnetic electrode 221 or the second electromagnetic electrode 222 through the corresponding pads.

In some embodiments of the present disclosure, the electromagnetic control circuit 3 can be integrated in a driver chip, and the driver chip can be bound and connected to the pads.

For example, as shown in FIG. 20, FIG. 21, FIG. 22 and FIG. 23, in some embodiments of the present disclosure, the first traces 41 and the third electromagnetic electrode 223 can be arranged on two sides of the display area AA, respectively.

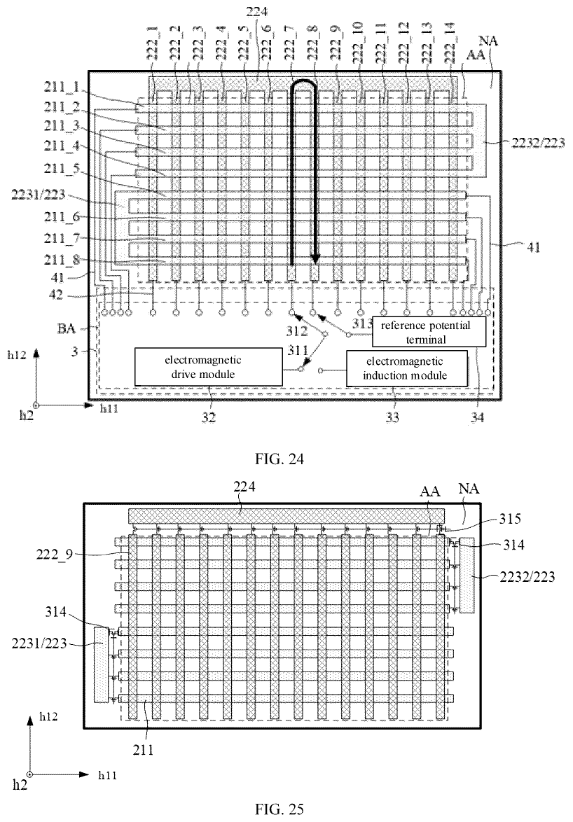

Alternatively, as shown in FIG. 24, which is a schematic diagram of another display panel according to some embodiments of the present disclosure. In some embodiments of the present disclosure, the plurality of first traces 41 can be divided into two parts, along the first direction h11, a part of the first traces 41 is at least partially located on a side of the display area AA and the other part of the first traces 41 is at least partially located on the other side of the display area AA. Based on this setting method, the width of the non-display area NA located on two sides of the display area AA can be balanced, thereby avoiding the width of the non-display area NA located on one side of the display area AA being too large.

For example, as shown in FIG. 24, the third electromagnetic electrode 223 includes a first electromagnetic sub-electrode 2231 and a second electromagnetic sub-electrode 2232. The first electromagnetic sub-electrode 2231 is electrically connected to a part of the first electromagnetic electrodes 221, and the second electromagnetic sub-electrode 2232 is electrically connected to the other part of the first electromagnetic electrodes 221. For example, the number of the first electromagnetic electrodes 221 electrically connected to the first electromagnetic sub-electrode 2231 and the number of the first electromagnetic electrodes 221 electrically connected to the second electromagnetic sub-electrode 2232 may both be greater than 2.

Along the first direction h11, the first electromagnetic sub-electrode 2231 and the second electromagnetic sub-electrode 2232 are located on two sides of the display area AA to balance the width of the non-display area NA located on two sides of the display area AA, thereby avoiding the width of the non-display area NA located on one side of the display area AA being too large.

It should be noted that in order to clearly illustrate the first electromagnetic electrode 221 and the second electromagnetic electrode 222, the first capacitor electrode and the second capacitor electrode are omitted in FIG. 20, FIG. 21, FIG. 22, FIG. 23, and FIG. 24.

As shown in FIG. 21, FIG. 22, FIG. 23, and FIG. 24, along the second direction h12, the electromagnetic control circuit 3 is located on a side of the display area AA, and the fourth electromagnetic electrode 224 is located on a side of the display area AA away from the electromagnetic control circuit 3. In some embodiments of the present disclosure, by arranging the fourth electromagnetic electrode 224 and the electromagnetic control circuit 3 on two sides of the display area AA in the second direction h12, it is possible to avoid the problem of excessive width of the single-side frame of the display panel caused by both the fourth electromagnetic electrode 224 and the electromagnetic control circuit 3 being arranged on the same side of the display area AA.

For example, as shown in FIG. 25, which is a schematic diagram of another display panel according to some embodiments of the present disclosure, the display panel further includes a plurality of fourth switches 314 and a plurality of fifth switches 315. A first terminal and a second terminal of the fourth switch 314 are electrically connected to the first electromagnetic electrode 221 and the third electromagnetic electrode 223, respectively. A first terminal and a second terminal of the fifth switch 315 are electrically connected to the second electromagnetic electrode 222 and the fourth electromagnetic electrode 224, respectively. A control terminal of the fourth switch 314 and a control terminal of the fifth switch 315 can receive a touch mode control signal.

In some embodiments of the present disclosure, a touch process of the display panel includes an electromagnetic touch stage and a capacitive touch stage. During the electromagnetic touch stage, the touch mode control signal can control at least two fourth switches 314 to be turned on, and the first electromagnetic electrodes 221 and the third electromagnetic electrodes 223 electrically connected to the at least two fourth switches 314 form a first electromagnetic coil. Alternatively, the touch mode control signal can control at least two fifth switches 315 to be turned on, and the second electromagnetic electrodes 222 and the fourth electromagnetic electrodes 224 electrically connected to the at least two fifth switches 315 form a second electromagnetic coil.

During the capacitive touch stage, the touch mode control signal can control the fourth switches 314 to be turned off, and control the fifth switches 315 to be turned off. The first electromagnetic electrode 221 is reused as the first capacitor electrode 211, and the second electromagnetic electrode 222 is reused as the second capacitor electrode 212. Based on this setting method, only one electrode structure is required to be provided in the display panel, so that the display panel can support finger touch and stylus touch, and the structure of the display panel is simplified.

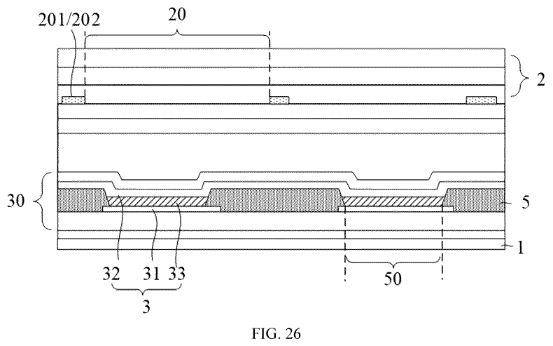

For example, as shown in FIG. 26, which is a schematic cross-sectional view of another display panel according to some embodiments of the present disclosure, in some embodiments of the present disclosure, the display film layer 30 includes a pixel definition layer 5 located above a side of the touch layer 2 close to the substrate 1. The pixel definition layer 5 includes a plurality of pixel openings 50. At least one of the first capacitor electrode, the second capacitor electrode, the first capacitor connecting portion, the second capacitor connecting portion, the first electromagnetic electrode, the second electromagnetic electrode, the first electromagnetic connecting portion and the second electromagnetic connecting portion includes grid openings 20, and the grid opening 20 at least partially overlaps the pixel opening 50 in the direction h2 perpendicular to the plane of the substrate 1.

As shown in FIG. 26, the display panel further includes a sub-pixel 3. The sub-pixel 3 includes a first electrode 31, a second electrode 32, and a light-emitting layer 33, and the light-emitting layer 33 is at least partially located in the pixel opening 50. Orthogonal projections of a first metal wire 201 and a second metal wire 202 on the plane of the substrate 1 are located between two adjacent pixel openings 50. In some embodiments of the present disclosure, the sub-pixel 3 includes an organic light-emitting diode or an inorganic light-emitting diode.

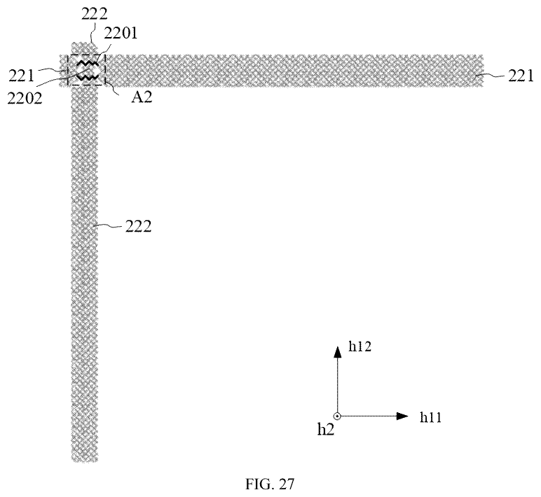

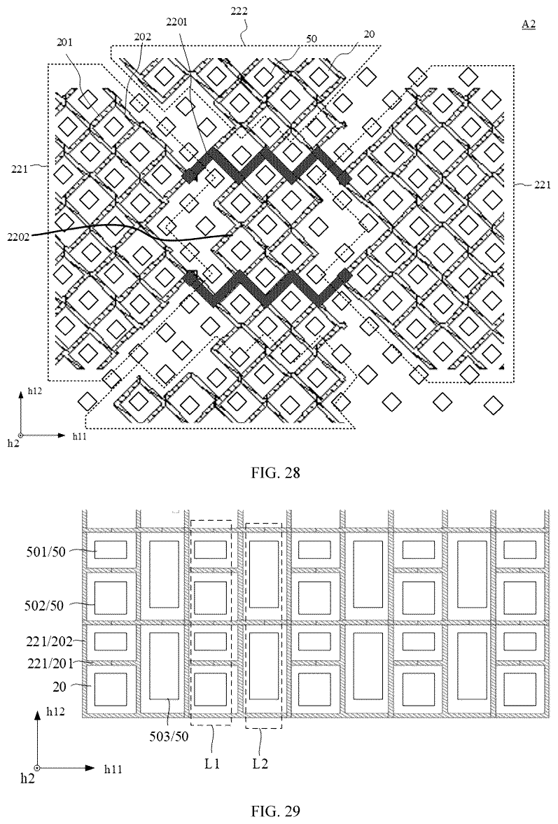

As shown in FIG. 27 and FIG. 28, where FIG. 27 is a schematic diagram of an electromagnetic touch unit according to some embodiments of the present disclosure, and FIG. 28 is an enlarged schematic diagram of an area A2 in FIG. 27, in some embodiments of the present disclosure, at least one of the first capacitor electrode 211, the second capacitor electrode 212, the first capacitor connecting portion 2131, the second capacitor connecting portion 2132, the first electromagnetic electrode 221, the second electromagnetic electrode 222, the first electromagnetic connecting portion 2201 and the second electromagnetic connecting portion 2202 includes the first metal wire 201 and the second metal wire 202 whose extension directions intersect with each other and electrically connected to each other. First metal wires 201 and second metal wires 202 intersect with each other to form grid openings 20. The first metal wire 201 and the second metal wire 202 are arranged to avoid the pixel opening 50. That is, the orthogonal projection of the pixel opening 50 on the plane of the substrate 1 does not overlap the orthogonal projection of the first metal wire 201 on the plane of the substrate 1, and the orthogonal projection of the pixel opening 50 on the plane of the substrate 1 does not overlap the orthogonal projection of the second metal wire 202 on the plane of the substrate 1. Based on this setting method, it is possible to avoid the first metal wire 201 and the second metal wire 202 affecting the light emission of the sub-pixel located in the pixel opening 50, thereby ensuring the display effect of the display panel. For example, the line widths of the first metal wire 201 and the second metal wire 202 are smaller than the spacing between two adjacent pixel openings 50, and the orthogonal projections of the first metal wire 201 and the second metal wire 202 on the plane of the substrate 1 may be located between two adjacent pixel openings 50, respectively.

The cross-arrangement of the first metal wires 201 and the second metal wires 202 is equivalent to connecting a plurality of first metal wires 201 in parallel, and connecting a plurality of second metal wires 202 in parallel, so that the conduction paths of the touch signal in the first capacitor electrode 211, the second capacitor electrode 212, the first capacitor connecting portion 2131, the second capacitor connecting portion 2132, the first electromagnetic electrode 221, the second electromagnetic electrode 222, the first electromagnetic connecting portion 2201 and the second electromagnetic connecting portion 2202 can be increased, and the resistance of the first capacitor electrode 211, the second capacitor electrode 212, the first capacitor connecting portion 2131, the second capacitor connecting portion 2132, the first electromagnetic electrode 221, the second electromagnetic electrode 222, the first electromagnetic connecting portion 2201 and the second electromagnetic connecting portion 2202 can be reduced, which can reduce the delay of the touch signal in the touch operation, and improve the touch effect of the display panel.

It should be noted that in FIG. 28, the linear structure of the first electromagnetic connecting portion 2201 is only illustrative. In some embodiments of the present disclosure, the first electromagnetic connecting portion 2201 may also be configured to include a structure including the grid opening 20, which is not shown in the drawings.

It should be noted that in FIG. 28, the arrangement of the pixel openings 50 is only illustrative and is not intended to limit the present disclosure. For example, as shown in FIG. 29, which is a schematic diagram of a first electromagnetic electrode and a pixel opening according to some embodiments of the present disclosure, the first metal wire 201 forming the first electromagnetic electrode 221 can extend in the first direction h11, and the second metal wire 202 forming the first electromagnetic electrode 221 can extend in the second direction h12; the pixel openings 50 can include first pixel openings 501, second pixel openings 502, and third pixel openings 503, and along the second direction h12, the first pixel openings 501 and the second pixel openings 502 are alternately arranged to form a first column L1, the third pixel openings 503 can be arranged to form a second column L2, and first columns L1 and second columns L2 can be alternately arranged in the first direction h11.

For example, the third electromagnetic electrode 223 and the fourth electromagnetic electrode 224 shown in FIG. 20, FIG. 21, FIG. 22, FIG. 23, FIG. 24 and FIG. 25 can be provided with a structure that does not include the grid openings, and the sub-pixel is not required to be provided in the non-display area NA where the third electromagnetic electrode 223 and the fourth electromagnetic electrode 224 are located. Therefore, in some embodiments of the present disclosure, by setting the third electromagnetic electrode 223 and the fourth electromagnetic electrode 224 to a structure without grid openings, it is beneficial to increase the width of the third electromagnetic electrode 223 and the width of the fourth electromagnetic electrode 224, thereby reducing the resistance of the third electromagnetic electrode 223 and the resistance of the fourth electromagnetic electrode 224.

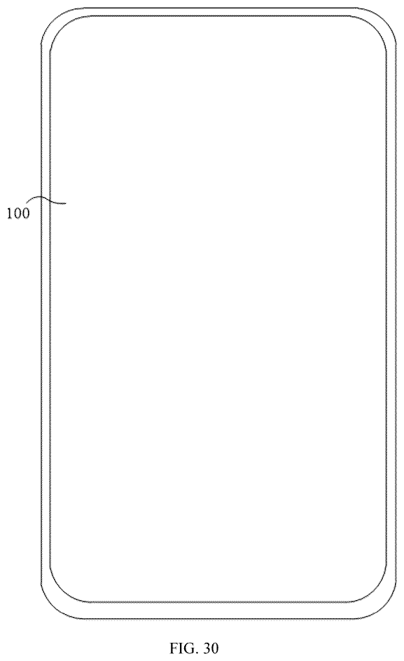

Based on the same inventive concept, an embodiment of the present disclosure further provide a display apparatus, as shown in FIG. 30, which is a schematic diagram of a display apparatus according to some embodiments of the present disclosure, the display apparatus includes the display panel 100 described above. The specific structure of the display panel 100 has been described in detail in the above embodiments, which will not be elaborated herein. The display apparatus shown in FIG. 30 is just for schematic illustration. The display apparatus can be any apparatus with a display function, such as a mobile phone, a car display screen, a tablet computer, a laptop, an e-book or a television.

The above description is merely preferred embodiments of the present disclosure, and is not intended to limit the present disclosure. Any modification, equivalent substitution, improvement, etc. made within the spirit and principle of the present disclosure shall fall within the protection scope of the present disclosure.

It should be noted that the above embodiments are merely used to illustrate the technical solutions of the present disclosure, rather than to limit it. Although the present disclosure has been described in detail with reference to the above embodiments, those skilled in the art should understand that they can still modify the technical solutions described in the above embodiments, or replace some or all of the technical features therein by equivalents. However, these modifications or replacements do not make the essence of the corresponding technical solutions deviate from the scope of the technical solutions of the embodiments of the present disclosure.

What is claimed is:

1. A display panel, comprising:
a substrate; and
a touch layer located above a side of the substrate;
wherein the touch layer comprises a capacitive touch unit and an electromagnetic touch unit, the capacitive touch unit is configured to sense a first input operation, and the electromagnetic touch unit is configured to sense a second input operation;
the capacitive touch unit comprises a first capacitor electrode and a second capacitor electrode whose extension directions intersect with each other, and the electromagnetic touch unit comprises a first electromagnetic electrode and a second electromagnetic electrode whose extension directions intersect with each other;
at least one of the first electromagnetic electrode and the second electromagnetic electrode is disposed in a different layer from the first capacitor electrode, or at least one of the first electromagnetic electrode and the second electromagnetic electrode is disposed in a different layer from the second capacitor electrode;
the capacitive touch unit further comprises capacitor connecting portions, the capacitor connecting portions comprise a first capacitor connecting portion and a second capacitor connecting portion, two adjacent first capacitor electrodes are electrically connected to each other through at least one first capacitor connecting portion, and two adjacent second capacitor electrodes are electrically connected to each other through at least one second capacitor connecting portion;
the electromagnetic touch unit further comprises electromagnetic connecting portions, the electromagnetic connecting portions comprise a first electromagnetic connecting portion and a second electromagnetic connecting portion, two adjacent first electromagnetic electrodes are electrically connected to each other through at least one first electromagnetic connecting portion, and two adjacent second electromagnetic electrodes are electrically connected to each other through at least one second electromagnetic connecting portion; and
the first electromagnetic connecting portion is disposed in a same layer as one of the first capacitor connecting portion and the second capacitor connecting portion, or the second electromagnetic connecting portion is disposed in a same layer as one of the first capacitor connecting portion and the second capacitor connecting portion.

2. The display panel according to claim 1, wherein, along a direction perpendicular to a plane of the substrate, any one of the capacitor connecting portions and any one of the capacitor connecting portions are disposed in a staggered manner.

3. The display panel according to claim 1, wherein the first electromagnetic connecting portion and the second electromagnetic connecting portion are disposed in different layers;
the first electromagnetic electrode and the first electromagnetic connecting portion are disposed in a same layer; and
the second electromagnetic electrode and the second electromagnetic connecting portion are disposed in a same layer.

4. The display panel according to claim 3, wherein the touch layer comprises a first touch metal layer, a second touch metal layer and a third touch metal layer disposed in a stacked manner;
the first touch metal layer comprises one of the first electromagnetic electrode and the second electromagnetic electrode;
the second touch metal layer comprises the other of the first electromagnetic electrode and the second electromagnetic electrode, and the second capacitor connecting portion; and
the third touch metal layer comprises the first capacitor electrode, the first capacitor connecting portion and the second capacitor electrode.

5. The display panel according to claim 4, wherein an organic insulating layer is disposed between any two adjacent ones of the first touch metal layer, the second touch metal layer, and the third touch metal layer.

6. The display panel according to claim 1, wherein the first electromagnetic electrode, the first electromagnetic connecting portion and the second electromagnetic electrode are disposed in a same layer; and
the second electromagnetic electrode and the second electromagnetic connecting portion are disposed in different layers.

7. The display panel according to claim 6, wherein the touch layer comprises a first touch metal layer, a second touch metal layer and a third touch metal layer disposed in a stacked manner;
the first touch metal layer comprises the first electromagnetic electrode, the first electromagnetic connecting portion and the second electromagnetic electrode;
the second touch metal layer comprises the second capacitor connecting portion and the second electromagnetic connecting portion; and
the third touch metal layer comprises the first capacitor electrode, the second capacitor electrode and the first capacitor connecting portion.

8. The display panel according to claim 7, wherein an organic insulating layer is disposed between any two adjacent ones of the first touch metal layer, the second touch metal layer, and the third touch metal layer.

9. The display panel according to claim 1, wherein the first electromagnetic electrode and the second electromagnetic electrode respectively comprise a first structure and a second structure disposed in a stacked manner and electrically connected to each other; and
the display panel further comprises a first insulating layer disposed between the first structure and the second structure, the first insulating layer comprises a via, the first structure and the second structure of the first electromagnetic electrode are electrically connected to each other through at least two vias, and the first structure and the second structure of the second electromagnetic electrode are electrically connected to each other through at least two vias.

10. The display panel according to claim 9, wherein one of the first structure and the second structure is disposed in a same layer as the first electromagnetic connecting portion; and
the other of the first structure and the second structure is disposed in a same layer as the second electromagnetic connecting portion.

11. The display panel according to claim 10, wherein the touch layer comprises a first touch metal layer, a second touch metal layer and a third touch metal layer disposed in a stacked manner;
the first touch metal layer comprises the first structure and the first electromagnetic connecting portion;
the second touch metal layer comprises the second structure and the second electromagnetic connecting portion;
the first touch metal layer or the second touch metal layer comprises the second capacitor connecting portion; and
the third touch metal layer comprises the first capacitor electrode, the second capacitor electrode, and the first capacitor connecting portion.

12. The display panel according to claim 1, further comprising:
a display area and a non-display area;
wherein the first electromagnetic electrode and the second electromagnetic electrode are at least partially located in the display area; and
the non-display area comprises a third electromagnetic electrode and a fourth electromagnetic electrode, the third electromagnetic electrode is electrically connected to one end of at least two first electromagnetic electrodes, and the fourth electromagnetic electrode is electrically connected to one end of at least two second electromagnetic electrodes.

13. The display panel according to claim 12, further comprising:
an electromagnetic control circuit;
wherein the electromagnetic control circuit is electrically connected to another end of the at least two first electromagnetic electrodes or the other end of the at least two second electromagnetic electrodes; and
the electromagnetic control circuit is located on a side of the display area away from the fourth electromagnetic electrode.

14. The display panel according to claim 13, wherein the electromagnetic control circuit comprises a first switch, an electromagnetic drive module and an electromagnetic induction module;
an electromagnetic touch process of the display panel comprises an electromagnetic drive stage and an electromagnetic induction stage;
the first switch is electrically connected to the electromagnetic drive module and the electromagnetic touch unit during the electromagnetic drive stage; and
the first switch is electrically connected to the electromagnetic induction module and the electromagnetic touch unit during the electromagnetic induction stage.

15. The display panel according to claim 13, wherein the electromagnetic control circuit further comprises a second switch and a third switch; and
the second switch and the third switch are electrically connected to two first electromagnetic electrodes to form a first electromagnetic coil, or the second switch and the third switch are electrically connected to two second electromagnetic electrodes to form a second electromagnetic coil.

16. The display panel according to claim 12, wherein the non-display area further comprises a plurality of first traces, and one of the first traces is electrically connected to the first electromagnetic electrode; and
a part of the first traces is at least partially located on one side of the display area, and the other part of the first traces is at least partially located on the other side of the display area.

17. The display panel according to claim 16, wherein the third electromagnetic electrode comprises a first electromagnetic sub-electrode and a second electromagnetic sub-electrode, the first electromagnetic sub-electrode is electrically connected to a part of first electromagnetic electrodes, and the second electromagnetic sub-electrode is electrically connected to another part of the first electromagnetic electrodes; and
the first electromagnetic sub-electrode and the second electromagnetic sub-electrode are located on two sides of the display area.

18. The display panel according to claim 12, further comprising:
a plurality of fourth switches and a plurality of fifth switches;
wherein a first terminal and a second terminal of one of the fourth switches are electrically connected to the first electromagnetic electrode and the third electromagnetic electrode, respectively, and a first terminal and a second terminal of one of the fifth switches are electrically connected to the second electromagnetic electrode and the fourth electromagnetic electrode, respectively;
a touch process of the display panel comprises an electromagnetic touch stage and a capacitive touch stage;
during the electromagnetic touch stage, at least two of the fourth switches are turned on, and the first electromagnetic electrodes and the third electromagnetic electrodes electrically connected to the at least two of the fourth switches form a first electromagnetic coil, or at least two of the fifth switches are turned on, and the second electromagnetic electrodes and the fourth electromagnetic electrodes electrically connected to the at least two of the fifth switches form a second electromagnetic coil; and
during the capacitive touch stage, the fourth switches are turned off, the fifth switches are turned off, the first electromagnetic electrode is reused as the first capacitor electrode, and the second electromagnetic electrode is reused as the second capacitor electrode.

19. The display panel according to claim 1, further comprising:
a pixel definition layer located on a side of the touch layer close to the substrate;
wherein the pixel definition layer comprises a plurality of pixel openings; and
at least one of the first capacitor electrode, the second capacitor electrode, the first electromagnetic electrode and the second electromagnetic electrode comprises a grid opening, and the grid opening at least partially overlaps one of the pixel openings along a direction perpendicular to a plane of the substrate.

20. A display apparatus, comprising a display panel;
wherein the display panel comprises:
a substrate; and
a touch layer located on a side of the substrate;
wherein the touch layer comprises a capacitive touch unit and an electromagnetic touch unit, the capacitive touch unit is configured to sense a first input operation, and the electromagnetic touch unit is configured to sense a second input operation;
the capacitive touch unit comprises a first capacitor electrode and a second capacitor electrode whose extension directions intersect with each other, and the electromagnetic touch unit comprises a first electromagnetic electrode and a second electromagnetic electrode whose extension directions intersect with each other;
at least one of the first electromagnetic electrode and the second electromagnetic electrode is disposed in a different layer from the first capacitor electrode, or at least one of the first electromagnetic electrode and the second electromagnetic electrode is disposed in a different layer from the second capacitor electrode;
the capacitive touch unit further comprises capacitor connecting portions, the capacitor connecting portions comprise a first capacitor connecting portion and a second capacitor connecting portion, two adjacent first capacitor electrodes are electrically connected to each other through at least one first capacitor connecting portion, and two adjacent second capacitor electrodes are electrically connected to each other through at least one second capacitor connecting portion;
the electromagnetic touch unit further comprises electromagnetic connecting portions, the electromagnetic connecting portions comprise a first electromagnetic connecting portion and a second electromagnetic connecting portion, two adjacent first electromagnetic electrodes are electrically connected to each other through at least one first electromagnetic connecting portion, and two adjacent second electromagnetic electrodes are electrically connected to each other through at least one second electromagnetic connecting portion; and
the first electromagnetic connecting portion is disposed in a same layer as one of the first capacitor connecting portion and the second capacitor connecting portion, or the second electromagnetic connecting portion is disposed in a same layer as one of the first capacitor connecting portion and the second capacitor connecting portion.
